(19) United States
(12) Patent Application Publication
(10) Pub. No.: US 2006/0110605 A1
(43) Pub. Date: May 25, 2006

(54) Hydrophilic coating and method of making same

(75) Inventors: Henry A. Luten, Ypsilanti, MI (US); Joseph M. Bienkiewicz, Ann Arbor, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/007,583

(22) Filed: Dec. 9, 2004

Related U.S. Application Data
(63) Continuation-in-part of application No. 10/996,046, filed on Nov. 24, 2004.

(51) Int. Cl. B32B 17/06; B32B 27/00

(52) U.S. Cl. 428/428; 428/702; 428/500; 427/446; 427/226

(57) ABSTRACT

A vehicle window is provided with a hydrophilic coating. A silicon oxide layer of the window may be deposited using flame pyrolysis so that the surface of the silicon oxide layer is textured at the sub-micron level in order to improve the coating's hydrophilic properties. Optionally, an overcoat layer may be provided over the flame pyrolysis deposited layer.

This application is a continuation-in-part (CIP) of U.S. Ser. No. 10/996,046, filed Nov. 24, 2004, the entire disclosure of which is hereby incorporated herein by reference.

This invention relates to a vehicle window. In certain example embodiments of this invention, a hydrophilic coating is provided on the interior surface of the vehicle window.

### BACKGROUND OF THE INVENTION

Vehicle windows are susceptible to fogging up in certain environmental conditions, especially the interior surface thereof. Unfortunately, conventional anti-fog systems such as a grid of conductors with a pair of corresponding bus bars cannot be practically used in certain applications, and also are costly to manufacture.

In view of the above, it will be apparent that there exists a need in the art for a vehicle window that is resistant to fogging up (e.g., that has a hydrophilic coating).

### SUMMARY OF EXAMPLE EMBODIMENTS OF INVENTION

Certain example embodiments of this invention relate to a window structure for use as a vehicle window such as a rear window in a pick-up truck or the like. In certain instances, the window structure may include a slidable window panel or sheet located between a pair of fixed window panels or sheets.

In certain example embodiments of this invention, the interior surface of the vehicle window is provided with a hydrophilic coating. The hydrophilic coating functions to prevent or reduce the tendency of the window to fog up during certain environmental conditions.

In certain example embodiments of this invention, there is provided a method of making a vehicle window, the method comprising forming a window by using flame pyrolysis to deposit a layer comprising silicon oxide on a glass substrate (directly or indirectly with other layer(s) therebetween) thereby forming a hydrophilic layer having a contact angle θ of less than about 25 degrees.

In other example embodiments of this invention, there is provided a method of making a vehicle window, the method comprising providing a glass substrate, forming a hydrophilic coating on the glass substrate, wherein the coating includes at least a layer comprising silicon oxide, and using flame pyrolysis to deposit the layer comprising silicon oxide, and wherein the coating has a contact angle θ of less than about 25 degrees.

In other example embodiments of this invention, there is provided a coated article comprising a glass substrate, and a hydrophilic coating on the glass substrate, the hydrophilic coating comprising a layer comprising silicon oxide that is formed via flame pyrolysis in order to texture an outer surface of the layer so as to cause the layer comprising silicon oxide to realize a contact angle θ of less than about 25 degrees.

### BRIEF DESCRIPTION OF THE DRAWINGS

FIG. 1 is a cross sectional view of a coated article such as a vehicle window according to an example embodiment of this invention.

FIG. 2 is a side cross sectional partially schematic view illustrating a contact angle θ of a drop (e.g., sessile drop of water) on an uncoated glass substrate.

FIG. 3 is a side cross sectional partially schematic view illustrating a high contact angle θ of a drop on a coated article including a hydrophobic coating.

FIG. 4 is a side cross sectional partially schematic view illustrating a low contact angle θ of a drop (e.g., sessile drop of water) on a coated article according to an example embodiment of this invention with a hydrophilic coating.

### DETAILED DESCRIPTION OF EXAMPLE EMBODIMENTS OF INVENTION

Referring now more particularly to the accompanying drawings in which like reference numerals indicate like parts throughout the several views.

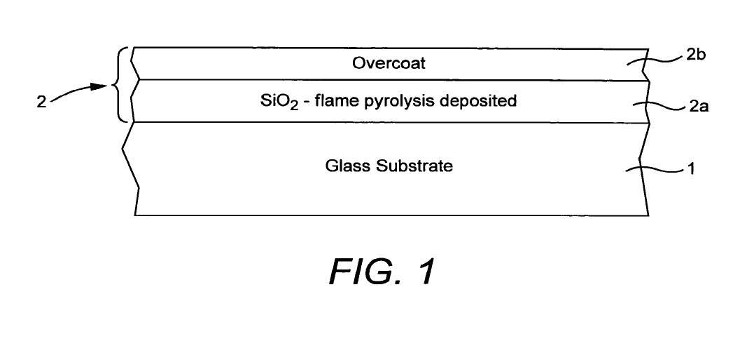

FIG. 1 is a cross sectional view of a coated article according to an example embodiment of this invention. The coated article of FIG. 1 may be used as a vehicle window, or any other suitable application where a hydrophilic coating is desired. The coated article of FIG. 1 includes glass substrate 1 which supports a hydrophilic coating 2 on a surface thereof. In certain example embodiments, the hydrophilic coating 2 may be on the interior surface of the glass substrate 1 so as to face the vehicle interior. The hydrophilic coating 2 may be made up of one or more layers in different embodiments of this invention. The hydrophilic coating 2 is advantageous in that it functions in an anti-fogging manner so as to prevent or reduce fogging up of the interior surface of the window.

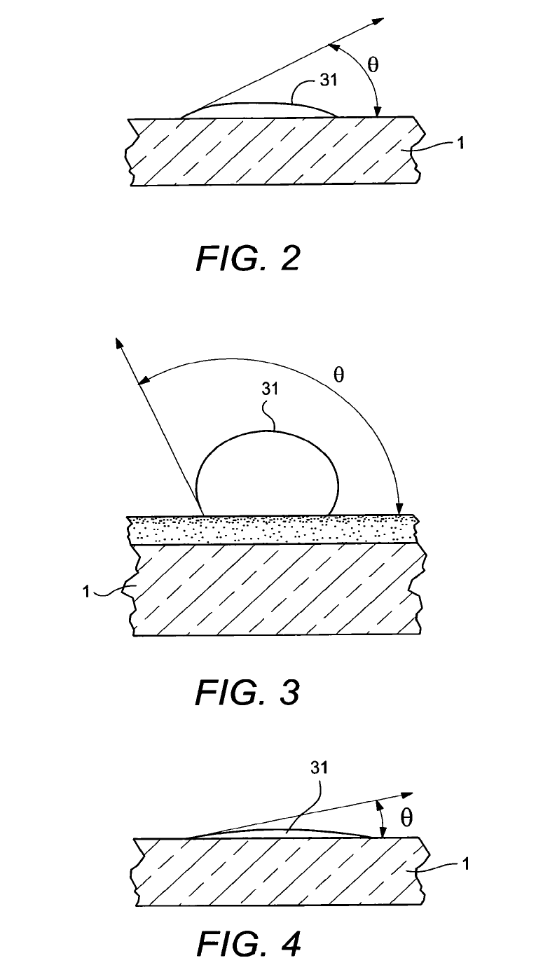

Hydrophilic performance of coating 2 is a function of contact angle θ, surface energy Υ, and/or wettability or adhesion energy W. The surface energy Υ of the coating 2 may be calculated by measuring its contact angle θ. Exemplary contact angles θ are illustrated in FIGS. 2-4. A hydrophilic coating or layer system 2 according to an embodiment of this invention is on the substrate of FIG. 4 (i.e., low contact angle θ), while no coating of any kind is on the substrate of FIG. 2 and a hydrophobic coating (high contact angle) is on the substrate of FIG. 3. No coatings are illustrated in FIGS. 2 and 4 for purposes of simplicity. To measure contact angle θ in an example embodiment, a sessile drop 31 of a liquid such as water is placed on the substrate (which may be coated) as shown in FIGS. 2-4. A contact angle θ between the drop 31 and underlying article appears, defining an angle θ depending upon the interface tension between the three phases at the point of contact. The contact angle θ is greater in FIG. 3 than in FIG. 2, because the coating on the substrate in FIG. 3 is hydrophobic (i.e., results in a higher contact angle). However, in certain embodiments of this invention, the contact angle θ in FIG. 4 is low thereby indicating a hydrophilic nature of the coating 2 (not shown in FIG. 4) on the substrate 1.

Hydrophilic coating includes layer 2a which may be made of a materials such as silicon oxide (e.g., SiO₂). Optional overcoat layer 2b may also be provided in certain example embodiments of this invention.

In certain example embodiments, the hydrophilic nature (i.e., low contact angle) of the layer 2a is due to the flame pyrolysis deposition of silicon oxide layer as layer 2a. Silicon oxide inclusive layer 2a as deposited via flame pyrolysis on substrate 1 is quite hydrophilic in nature. Surprisingly, it has been found that the use of flame pyrolysis to deposit a layer 2a of or including silicon oxide results in such a layer which has a relatively high surface energy Υ_{c} and thus a low contact angle θ. The silicon oxide layer 2a is textured at the outer surface thereof at the sub-micron level due to the flame pyrolysis deposition which improves the layer's hydrophilic properties (i.e., lowers its contact angle) and also the hydrophilic properties of an optional overcoat.

The hydrophilic layer 2a of silicon oxide may alone be used as the hydrophilic coating 2 in certain example embodiments of this invention, or alternatively an additional overcoat layer 2b of or including a material such as polyacrylic acid may also be provided on the substrate 1 over layer 2a in order to enhance the hydrophilic properties of the coated article. An example advantage of a hybrid approach, including both hydrophilic layers 2a and 2b, is that progressive loss of the overcoat layer 2b over time would not result in a total loss of hydrophilic performance since the underlying hydrophilic layer 2a would still be present on the substrate.

The coated article of FIG. 1 (with or without layer 2b) may or may not be heat treated (e.g., thermally tempered) in different example embodiments of this invention. The silicon oxide layer 2a appears to survive tempering, which would allow stock sheets to be pre-coated with layer 2a and then be cut and bent and/or tempered into their final dimensions. Initial testing shows that there is a reduction of performance after tempering in certain instances. Moreover, it is noted that an overcoat 2b likely would not survive thermal tempering in certain example embodiments of this invention.

In view of the above, the hydrophilic coating 2 includes silicon oxide layer 2a, but may or may not include overcoat 2b in different embodiments of this invention.

Generally, the surface energy Υ_{c} of a coating 2 or any other article/layer can be determined by the addition of a polar and a dispersive component, as follows: Υ_{c}=Υ_{CP}+Υ_{CD}, where Υ_{CP} is the layer's/coating's polar component and Υ_{CD} the layer's/coating's dispersive component. The polar component of the surface energy represents the interactions of the surface mainly based on dipoles, while the dispersive component represents, for example, van der Waals forces, based upon electronic interactions. Generally speaking, the higher the surface energy Υ_{c} of coating 2, the more hydrophilic the coating (and coated article) and the lower the contact angle. Adhesion energy (or wettability) W can be understood as an interaction between polar with polar, and dispersive with dispersive forces, between the exterior surface of the coated article and a liquid thereon such as water. For a detailed explanation, see U.S. Pat. No. 6,713,179 (incorporated herein by reference). In certain example embodiments of this invention, the surface energy Υ_{C} of hydrophilic coating 2 may be at least about 20 mN/m, more preferably at least about 24 mN/m, and most preferably at least about 26 mN/m.

Moreover, a hydrophilic coating 2 according to any embodiment herein may be characterized by a low contact angle (θ). In certain example embodiments of this invention, hydrophilic layer or coating 2 (e.g., 2a alone, or 2a and 2b in combination) has a contact angle θ less than about 35 degrees, more preferably less than about 25 degrees, more preferably less than about 20 degrees, even more preferably less than about 15 degrees, and sometimes even less than about 10 degrees. This low contact angle may be an initial contact angle when the coating is formed, and/or may occur after formation of the coating. Moreover, the low contact angle θ may be permanent or temporary in different situations.

As mentioned above, hydrophilic layer 2a may be deposited on substrate 1 via flame pyrolysis in order to improve the layer's hydrophilic properties. Layer 2a may be made up of one or more layers of silicon oxide (e.g., SiO₂) deposited by flame pyrolysis in certain example embodiments of this invention. Such a layer 2a may be deposited for example, by introducing a gas such as a silane (e.g., TEOS) into at least one burner in order to cause a layer 2a of silicon oxide to be deposited via combustion CVD on the substrate 1 (e.g., glass or plastic substrate). In certain example instances, the flame pyrolysis may be performed at atmospheric pressure, so that a low pressure environment is not needed. Examples of flame pyrolysis are disclosed in, for example and without limitation, U.S. Pat. Nos. 3,883,336, 4,600,390, 4,620,988, 5,652,021, 5,958,361, and 6,387,346, the disclosures of all of which are hereby incorporated herein by reference.

Optional overcoat 2b may be deposited on substrate 1 over layer 2a in any suitable manner including but not limited to vapor deposition, liquid coating application, or the like. Optional overcoat 2b may be polymer based in certain example embodiments of this invention, and may be of or include polyacrylic acid in certain example embodiments in order to enhance the coated article's hydrophilic properties.

Optionally, additional layer(s) (not shown) may be provided between layer 2a and substrate 1, and/or between layers 2a and 2b.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making a vehicle window, the method comprising:
providing a glass substrate;
forming a hydrophilic coating on the glass substrate, wherein the coating includes at least a layer comprising silicon oxide; and
using flame pyrolysis to deposit the layer comprising silicon oxide, and wherein the coating has a contact angle θ of less than about 25 degrees.

2. The method of claim 1, wherein the coating has a contact angle θ of less than about 20 degrees.

3. The method of claim 1, wherein the coating has a contact angle θ of less than about 15 degrees.

4. The method of claim 1, wherein the coating has a contact angle θ of less than about 10 degrees.

5. The method of claim 1, wherein the flame pyrolysis comprises introducing a silane into a flame in depositing the layer comprising silicon oxide.

6. The method of claim 5, wherein the silane comprises TEOS.

7. The method of claim 1, wherein another layer is provided on the substrate between the substrate and the layer comprising silicon oxide.

8. The method of claim 1, further comprising forming an overcoat layer on the substrate over the layer comprising silicon oxide.

9. The method of claim 8, wherein the overcoat layer comprises polyacrylic acid.

10. The method of claim 8, wherein the overcoat layer is an organic layer.

11. The method of claim 8, wherein the overcoat layer is polymer based.

12. The method of claim 1, wherein the flame pyrolysis is performed at ambient pressure.

13. The method of claim 1, wherein the flame pyrolysis is performed so that an outer surface of the layer-comprising silicon oxide is textured at a sub-micron level thereby improving hydrophilic properties of the coating.

14. The method of claim 1, wherein the contact angle θ is an initial contact angle.

15. A method of making a coated article, the method comprising:
providing a glass substrate;
forming a hydrophilic coating on the glass substrate, wherein the coating includes at least a layer comprising silicon oxide; and
using flame pyrolysis to deposit the layer comprising silicon oxide so that the layer comprising silicon oxide is textured at a sub-micron level in order to improve the layer's hydrophilic properties, and wherein the coating has a contact angle θ of less than about 25 degrees.

16. The method of claim 15, wherein the coating has a contact angle θ of less than about 20 degrees.

17. The method of claim 15, wherein the coating has a contact angle θ of less than about 15 degrees.

18. A coated article comprising:
a glass substrate; and
a hydrophilic coating on the glass substrate, the hydrophilic coating comprising a layer comprising silicon oxide that is formed via flame pyrolysis in order to texture an outer surface of the layer comprising silicon oxide so as to cause the coating to realize a contact angle θ of less than about 25 degrees.

19. The coated article of claim 18, wherein the coating has a contact angle θ of less than about 20 degrees.

20. The coated article of claim 18, wherein the coating further comprising a layer comprising polyacrylic acid on the substrate provided over at least the layer comprising silicon oxide.
